(19) United States
(12) Patent Application Publication
(10) Pub. No.: US 2017/0137309 A1
(43) Pub. Date: May 18, 2017

(54) METHOD FOR TREATING CHROMIUM PRESENT IN EFFLUENTS, AND CORRESPONDING EQUIPMENT

(71) Applicants: MS DEVELOPPEMENT ET PARTICIPATIONS, Veyre-monton (FR); UNIVERSITE BLAISE PASCAL-CLERMONT II, Clermont-Ferrand cedex 01 (FR); CNRS CENTRE NATIONAL RECHERCHE SCIENTIFIQUE, PARS cedex 16 (FR); ECOLE NATIONALE SUPERIEURE CHIMIE CLERMONT-FERRAND-ENSCCF, AUBIERE cedex (FR)

(72) Inventors: Marcello BRIGANTE, Aubiere (FR); Benoit CHAMPEAU, Coudes (FR); Alexandre GUILLAUME, Ceyrat (FR); Gilles MAILHOT, Clermont-ferrand (FR); Romain PRULHO, Clermont-ferrand (FR)

(21) Appl. No.: 15/129,917

(22) PCT Filed: Mar. 23, 2015
(86) PCT No.: PCT/FR2015/050719

§ 371 Date: Sep. 28, 2016

(30) Foreign Application Priority Data
Mar. 28, 2014 (FR) 1452713

(51) Int. Cl. C02F 9/00

(52) U.S. Cl. CPC C02F 9/00; C02F 2101/22

(57) ABSTRACT

The method for reducing the chromium content, in particular the hexavalent chromium content, present in a liquid effluent loaded with solid particles, called the initial effluent (1), comprises at least one reduction step (9) by the addition, to the initial effluent, of a weak organic acid (10) in an amount sufficient to reduce the hexavalent chromium present in the initial effluent into a lower valency, namely into trivalent chromium, said step being followed by a step of discharging the treated liquid effluent, called the final effluent. It comprises at least a step of collecting the solid particles present in the initial effluent, at least by settling and a reduction step (9) which is performed after adjustment (12) of the pH of the initial effluent to a pH value lower than the initial pH of the initial effluent while remaining compatible with a discharge of the final effluent at this pH value. The invention also comprises a plant for implementing the method.

The present invention concerns a method for treating the chromium present in effluents as well as a corresponding plant.

The term effluent should be understood as referring to a liquid which, during its emission, is loaded with particles and/or compounds soluble in water. Thus, this liquid is an aqueous solution, even though other solvents may be present, as traces. Such an effluent is generated by human activities, namely industrial, agricultural or commercial activities, and this in every technical field.

Chromium is a transition metal which may exist in 6 oxidation states. Only the three-valent chromium, denoted Cr(III), and the six-valent chromium, denoted Cr(VI), are encountered in the natural state. The hexavalent chromium forms the second most stable oxidation state, while remaining rare in the natural state. The trivalent chromium is considered to be a micronutrient indispensable for humans and non-toxic at a small dose while the hexavalent chromium is a toxic element. It turns out that, because of its corrosion-resistant properties amongst others, chromium is commonly used in several fields of human activity. In particular, it is used in metallurgy, in the composition of steels where it improves the hardness and the resistance to corrosion of metals as well as in surface coating. Chromium is also used in the composition of refractory bricks and in the chemical industry, in particular in the field of leather tanning, textile industry, pigments, colorants, cleaning agents and adhesives.

Thus, chromium is likely to be present in the effluents derived from different industries, because of the solubility of chromium in water. It turns out that the hexavalent chromium, and therefore the potentially most toxic form, is very soluble in water, in contrast with the trivalent chromium which is barely soluble in water and has a tendency to be in a solid form, in a free or complexed state, in the effluents. Hence, there is a risk of finding trivalent and hexavalent chromium in soils, as regards the Cr(III) as such, and as regards the Cr(VI) by infiltration of the surface waters coming from the treatment of the effluents. There is a risk of pollution of the phreatic table and, more generally, of the underground waters by the soluble hexavalent chromium, which has a direct impact on public health.

Numerous governmental and/or international bodies have set in place regulations aiming to limit the chromium contents, generally the total chromium contents, in drinking waters. Other regulations appear and aim to reduce the chromium content in the effluents rejected by industries, by distinguishing the different oxidation states of chromium. As example, the French ministerial order of Nov. 26^{th}, 2011, imposes a maximum total chromium content of 0.1 mg/L and a maximum hexavalent chromium content of 0.05 mg/L in waters rejected in nature by concrete production plants, commonly called by the expression<<concrete mixing facility(ies)>>. Because of the produced tonnages, the effluents derived from the production of concretes constitute a considerable source of chromium. Indeed, the liquid effluents or slurries currently rejected by concrete mixing facilities generally contain from 0.1 mg/L to about 0.5 mg/L of hexavalent chromium, coming in particular from the concrete compounds, in particular from cements. There are known methods used in the laboratory scale, such as the method described by Xu X-R et Al, J. CHEMOSPHERE, 2004, Jul. 31, for reducing the chromium in an aqueous solution of potassium dichromate, not loaded with particles.

Hence, there is a need for an industrial treatment of effluents allowing reducing the chromium content in order to limit the impact of this element on nature and on public health. There is known, by document FR-A-2 791 662, an industrial method for treating effluents electrochemically. There are also known industrial precipitation methods based on the reduction of the hexavalent chromium, which is very soluble and toxic, into trivalent chromium, less soluble and barely toxic.

As example, as reducing agents, mention may be made to the use of sulfur dioxide (SO₂) and sodium bisulfite (NaHSO₃). The zero-valent iron or the iron(II) are also used. The methods using such reducing agents are not, or barely, considerable in an industrial scale. Indeed, besides a long reaction time, they require working in a very acid medium, at a pH lower than 4, while the initial pH of the effluents to be treated is very basic, generally close to 12. Therefore, a reduction of the pH from 12 to 4 or 3 requires a considerable consumption of pH adjusting agents, such as an acid, in order to perform the reaction. In addition, a pH lower than 4, and which is in addition generally close to 3, is incompatible with a direct rejection of the effluents in nature once treated, which implies a second adjustment of the pH to a pH, while not neutral, of at least 5.5 according to the regulations in force, prior to rejection, thereby an overconsumption of pH adjusting agents. Moreover, some of the products used and/or the sub-products generated in these methods are potentially toxic and/or difficult to eliminate.

There are known other methods, for example, bioremediation, activated carbon adsorption, photocatalyst, which are not easy to implement and/or are not at a reasonable cost, which does not allow for a use in an industrial scale.

There is also known, by document U.S. Pat. No. 6,221,002, a method for reducing the hexavalent chromium content present in soils which uses, as a reducing agent, a weak organic acid, in this instance the ascorbic acid. While such a method allows for a decrease of the hexavalent chromium content of more than 90%, it requires a minimum reaction time comprised between one and a few hours, which is incompatible with a rapid treatment of several cubic meters of liquid effluents, which are also loaded with solid particles.

In these conditions, the invention aims to propose a method for reducing the chromium content, in particular the Cr(VI) content, in the effluents which allows remedying to the above-described drawbacks of the prior art.

To this end, an object of the invention is a method for reducing the chromium content, in particular the hexavalent chromium content, present in a liquid effluent loaded with solid particles, called the initial effluent, comprising at least one reduction step by the addition, to the initial effluent, of a weak organic acid in an amount sufficient to reduce the hexavalent chromium present in the initial effluent into a lower valency, namely into trivalent chromium, said step being followed by a step of discharging the treated liquid effluent, called the final effluent, characterized in that it comprises at least the following steps of:
carrying out, prior to the reduction step, a step of collecting the solid particles present in the initial effluent, at least by settling,
performing the reduction step after adjustment of the pH of the initial effluent to a pH value lower than the initial pH of the initial effluent while remaining compatible with a discharge of the final effluent at this pH value.

The Applicant has surprisingly observed that the addition of a weak organic acid such as the ascorbic acid as a reducing agent in a slightly acid medium, for example with a pH comprised between 5 and 7, allows reducing the hexavalent chromium contained in an effluent in a time duration shorter than 30 minutes. Thus, it is possible to treat an effluent in a time duration compatible with the industrial constraints, the time duration of the treatment being then assimilated to the time duration of a continuous treatment of the effluent. Moreover, the pH of the effluent being slightly acid, the rejection of the treated final effluent is possible, without any complementary treatment. In addition, the use of a weak organic acid, herein the ascorbic acid, does not cause any potential degradation of the plants and does not generate any polluting sub-products.

According to advantageous, but not mandatory, aspects of the invention, such a method may comprise one or more of the following features:
The weak organic acid is the ascorbic acid and the adjustment of the pH is realized by the sulfuric acid.
The weak organic acid is the ascorbic acid and the adjustment of the pH is realized by the carbon dioxide.
The adjustment of the pH is realized so that the pH of the final effluent is comprised between 5.5 and 7.
During the settling step, the pH of the effluent is adjusted to a pH value close to the neutral pH.
The settling step is followed by a filtration.
Prior to the reduction step, the effluent is homogenized.
Subsequently to the homogenization and prior to the reduction, at least one measurement of the hexavalent chromium content and of the pH is performed.
During the reduction step, the weak organic acid is associated to at least one other compound.
The compound associated to the weak organic acid during the reduction step is a coagulant.

Another object of the invention is a plant for implementing the method according to any of the preceding features comprising at least one vat in which the reduction of an initial effluent is carried out, a member for adding a weak organic acid forming the reducing agent, the adding member being connected to said vat, characterized in that it also comprises at least one member for adjusting the pH of the initial effluent and at least one settling vat.

According to advantageous, but not mandatory, aspects of the invention, such a plant may comprise one or more of the following features:
The pH adjusting member is connected to the settling vat.
The plant comprises at least one filtering member such as a sand filter or an activated carbon filter.

The invention will be better understood and other advantages will appear clearly upon reading the description that will follow, given only as a non-limiting example and made with reference to the appended drawings, in which:

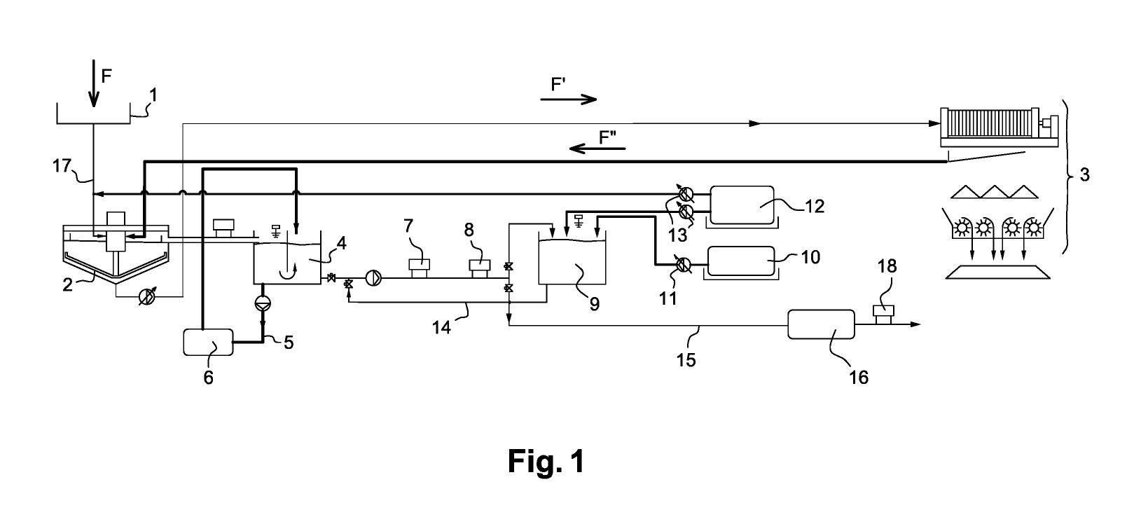

FIG. 1 is a schematic representation of a plant for implementing the method of the invention, according to one embodiment, the initial effluent to be treated comprising two phases, liquid and solid,

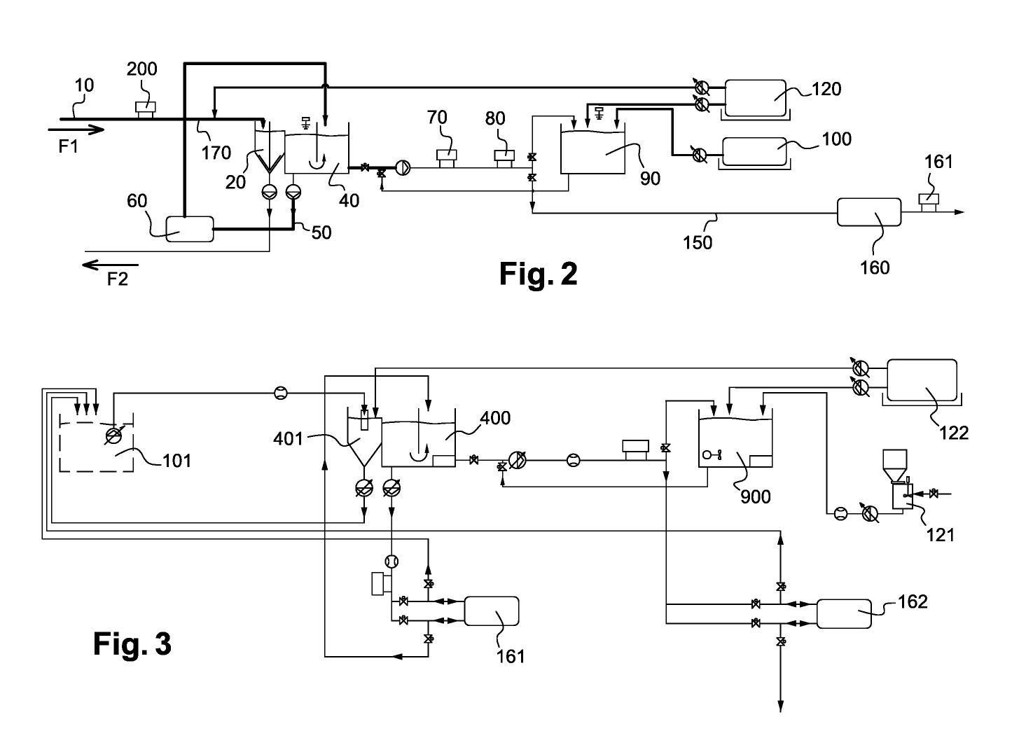

FIG. 2 is a diagram similar to FIG. 1, to the same scale, illustrating another embodiment of the invention in which the initial effluent has only but a liquid phase,

FIG. 3 is a diagram similar to the previous figures, to the same scale, of another embodiment of the invention, and

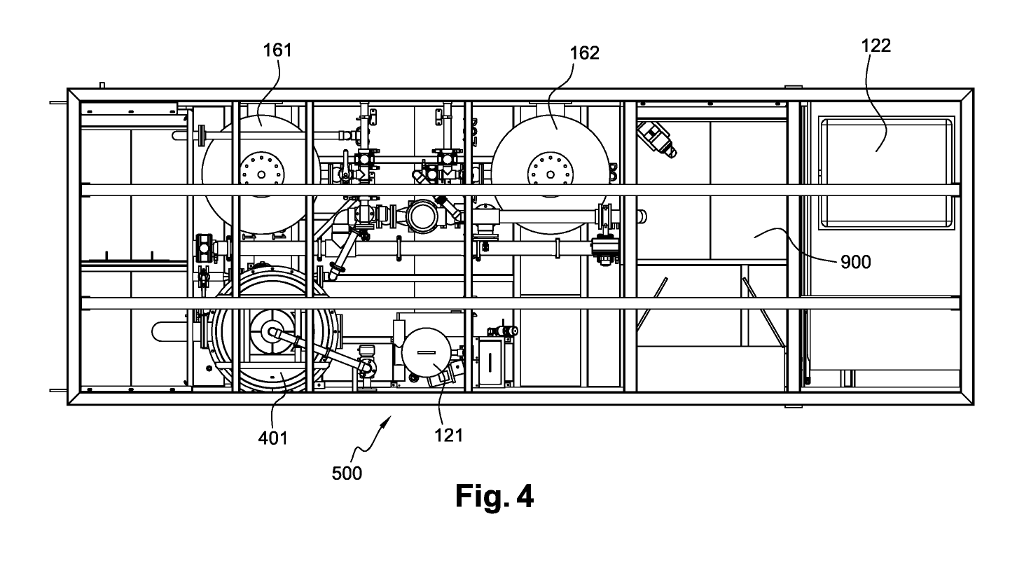

FIG. 4 is a simplified top view of a plant for implementing the method.

Herein, the embodiment of the invention represented in FIG. 1 is that of an effluent frequently encountered at the output of an industrial production plant. Such an effluent is named, in the following, the initial effluent. It consists of a liquid loaded with solid particles such as, for example but not exclusively, an effluent derived from the production of concrete, in a plant named, in the following, the concrete mixing facility, and commonly named the slurry. Such an effluent comprises an aqueous phase, forming the liquid phase in which chromium, basically the hexavalent chromium Cr(VI), is solubilized, and a solid phase formed by particles of sand, silica and other compounds of concrete, non-soluble in water. The trivalent chromium or Cr(III), barely soluble in water, is basically present in the solid phase and is adsorbed, at least partially, on the solid particles present in the initial effluent. The method illustrated in FIG. 1 provides for a treatment of the solid phase, in order to neutralize the latter prior to its discharge or its recycling.

FIG. 2 illustrates another embodiment of the invention corresponding to the case where the initial effluent, also derived from an industrial production plant, for example the production of concrete, is barely, or not at all, loaded with solid particles. In other terms, the initial effluent, herein a concrete slurry, has already undergone a treatment allowing separating the solid and liquid phases, for example but not exclusively, a settling step. The solid phase is treated separately, prior to its discharge or its recycling. Hence, in this case, the initial effluent is a settled slurry. In the following, the expression settled effluent or slurry will refer to an effluent devoid of solid particles even though the separation of the liquid and solid phases is carried out by a technique other than settling.

It is conceivable that the method of the invention applies to any type of effluent other than the concrete slurry, meaning an effluent comprising an aqueous phase, loaded with chromium, and generated by a human activity, whether industrial, agricultural, pharmaceutical, chemical or a food-processing activity. In the following, with reference to FIGS. 1 and 2, the expression initial slurry will also be used to refer to the initial effluent, that is to say the effluent untreated and loaded with chromium, whether this effluent includes one single aqueous phase or a solid phase and an aqueous phase. The expressions final slurry and final effluent are used indifferently to refer to the final effluent, that is to say cleared from chromium.

In a general manner, in the embodiments of the invention illustrated in FIGS. 1 and 2, the solid elements are treated and neutralized, by commonly-known methods, prior to their discharge or their recycling.

The method is now described, in a first embodiment, with reference to FIG. 1. In this case, the method is implemented at the outlet of effluents in a production plant, a concrete mixing facility in the example, prior to any treatment of the initial effluent, and therefore prior to the elimination of the solid particles. It is conceivable that the method could be either integrated in a plant which is an integral portion of a concrete mixing facility, or implemented in an independent plant located downstream of a concrete mixing facility. In other terms, it is possible either to design a concrete mixing facility inherently integrating a plant for implementing the method, or to equip an existing concrete mixing facility with such a plant.

In a first step, with reference to FIG. 1, the initial effluent, or initial slurry, loaded with solid particles, is brought on the implementation plant of the invention, from an outlet of a production plant, hence a concrete mixing facility, according to the arrow F, being understood that such an outlet also collects the rinsing waters of the various machines of the concrete mixing facility as well as the rinsing waters of the concrete transportation trucks called mixer trucks. In order to obtain a regular supply, the slurry arrives, advantageously but not mandatorily, in a supply tray 1, ensuring a temporary storage of the slurry. During this step, the slurry undergoes a natural settling allowing separating the solid particles and the liquid phase. For this purpose, the slurry is introduced in a commonly-known settling vat 2. The solid particles fall, by gravity, down to the bottom of the vat 2. Upon completion of the settling step, the muds, that is to say the solid phase, are collected, according to the arrow F′, and treated, in a commonly-known manner, so as to be stabilized prior to their final discharge. The reference numeral 3 is used to refer to the entire treatment of the filtrate. For example, the muds are pressed. The obtained galettes are compact and can be easily recovered. An additional stabilization step, which may be assimilated to a final treatment, allows a possible recycling or burying in accordance with the regulations in force. During this treatment 3, a liquid phase or filtrate, which is no longer or barely loaded with particles is reinjected in the vat 2, so as to be mixed with the clarified phase, according to the arrow F″.

In another embodiment, it is possible to consider performing a pH measurement on the slurry, before its settling, namely upstream of the vat 2. Such a pH measurement allows assessing the initial pH of the initial slurry. In another embodiment, when the initial effluent, for example from industrial origins, has a regular and known composition, this pH measurement is not carried out, or still, not systematically. Only a periodic sampling, allowing controlling the regularity of the effluent, is then performed.

The settled liquid phase, or supernatant, is taken up and homogenized, by stirring in a commonly-known vat 4, during a subsequent step. During this step, the liquid phase, basically loaded de facto with solubilized hexavalent chromium but also with other compounds, is advantageously maintained at a given temperature, close to ambient temperature, namely about 20° C., depending on the optimum conditions of the process. If necessary, a partial draw-off 5, of the slurry is performed during this step and is directed, via a pump, towards a filtration member 6, for example, a sand filter. The supernatant resulting from this filtration is sent back in the vat 4. Thus, by the filtration member 6, as much as possible of non-soluble particles is eliminated, so as to obtain a clarified solution containing only but solubilized compounds. During this draw-off, the trivalent chromium, Cr(III), non-solubilized and adsorbed on the particles, is collected in the filtrate. Alternatively, it is conceivable to use several filters 6 in parallel or in series in order to optimize the clarification of the solution.

Upon completion of this step, a measurement 7 of the chromium content of the clarified solution is advantageously, but not mandatorily, carried out at the output of the vat 4. Preferably, the measurement 7 is performed by samples and not in a continuous manner. Indeed, the methods for measuring the chromium content, commonly known, do not allow obtaining values rapidly, within time frames compatible with an industrial process. Alternatively, the measurement of the chromium content is not carried out, for example if the chromium content of the clarified solution is known because the initial slurry is homogenous and regular. In this case, the clarified solution is considered to basically contain hexavalent chromium Cr(VI). It is to be noted that the hexavalent chromium measurement allows assessing, by extrapolation, the total chromium content.

The next step, which may be performed concomitantly with the measurement 7 of the chromium content, is a measurement 8 of the pH of the clarified solution, downstream of the vat 4. Herein again, the measurement 8 may be omitted if it is considered that the clarified solution has a pH similar to that of the initial slurry, the pH of the latter being known.

Upon completion of this step, the clarified solution is directed towards a reaction vat 9 in which the reduction of the hexavalent chromium will be carried out. The vat 9 has a volume adapted to treat a corresponding volume of the clarified solution, substantially equal to the volume of the vat 4. In an advantageous embodiment which is not illustrated, at least two vats 9 are used in parallel. In this case, the volume of the vat 9 corresponds to half the volume of a vat 4, in the case where two vats 9 with the same volume are used in parallel. The vat 9 is equipped with a stirring means and with a means for maintaining temperature, commonly known. Alternatively, it is conceivable that more than two vats 9 are used.

In this vat 9, a reducing agent is added. The addition of this reducing agent, in this instance a weak organic acid, preferably the ascorbic acid or an ascorbic acid based mixture, is performed in a liquid form, from a supply vat 10 defining a member for adding the reducing agent. The addition of the ascorbic acid carried out advantageously in a liquid form facilitates the dispersion and the action of the reducing agent. This vat 10 is provided with means ensuring that the ascorbic acid solution is maintained homogenous and at a given temperature. A dosing means 11, such as a flowmeter, allows adapting the amount of reducing agent introduced in the vat 9. It is conceivable that, in order to ensure an optimum dispersion of the ascorbic acid in the clarified solution, the ascorbic acid is advantageously solubilized in a vat, called the preparer, preferably positioned proximate to the vat 9. Alternatively, the ascorbic acid is introduced directly in the vat 9 in a pulverulent form. The ascorbic acid has the advantage of being an organic acid easily degradable in nature and is considered to be harmless for living organisms, at least at the used doses, while being easy to produce at a reasonable cost.

In all cases, regardless of the form in which the ascorbic acid is introduced in the reaction vat 9, the addition to the effluent is carried out at a pH value comprised between the initial pH value of the initial effluent and a pH value compatible with the discharge of the final effluent at this pH value, without any additional adjustment of the pH. In this instance, considering the regulations, such a pH value allowing the discharge of the final effluent is, at least, 5.5. Indeed, it should be borne in mind that since the ascorbic acid is a weak acid and since the concrete slurries have a significant buffer effect, the addition of the ascorbic acid has slight, or even no, effect on the initial pH value. Hence, the pH of the reduction in the presence of the sole ascorbic acid would be performed at a pH value similar to that of the initial slurry, namely close to 12.

Still, tests practiced by the Applicant have shown, in an unexpected manner, a significant effect of the pH on the reduction of the hexavalent chromium, in particular on the reaction speed and on the yield of the latter, when all the other parameters, in particular the molar ratio between the hexavalent chromium and the ascorbic acid, are constant. The table hereinafter taken on the obtained results.

| | Molar ratio Cr(VI):Liquid ascorbic acid with 0.21 | | |
|---|---|---|---|
| | mg/L of Cr(VI) in the initial slurry | | |
| | 1:3 | 1:6 | 1:10 |
| | A* | B* | C* |
| pH > 8 and T = | No | No | No |
| 20° C. | reduction | reduction | reduction |
| 7 < pH < 8 and T = | No | >60% | >70% |
| 20° C. | reduction | reduction | reduction |
| | | in <10 min | in <10 min |
| 6 < pH < 7 and T = | Slow | >80% of | >90% of |
| 20° C. | reduction | Cr(VI) | Cr(VI) |
| | | reduced | reduced |
| | | in <10 min | in <10 min |

*mass equivalence for:
A: 0.21 mg/L Cr(VI) and 0.63 mg/L of ascorbic acid
B: 0.21 mg/L Cr(VI) and 1.26 mg/L of ascorbic acid
C: 0.21 mg/L Cr(VI) and 2.10 mg/L of ascorbic acid

The measurement of the hexavalent chromium remaining in the slurry before and after reduction has been performed by ion chromatography, according to a method adapted to provide reliable values, in a time duration shorter than 15 min and with a detection threshold of 2 μg/L (0.002 mg/L) of Cr(VI) and a quantification threshold in the range of 8 μg/L (0.008 mg/L).

It comes out from the tests that, starting from a molar ratio close to 1:10 and a pH comprised between 5.5 and 7, the reduction of the hexavalent chromium is considered to be complete about 10 minutes later. It is to be noted that the theoretical optimum molar ratio is 1:3 but the particular nature of the slurries makes this ratio unadapted, because of other reducible species present in solution in concrete slurries.

The Applicant has also studied the effect of other parameters on the reaction of reduction of hexavalent chromium by the ascorbic acid. In particular, a decrease of temperature of 10° C. relative to the temperature of the tests, which is the ambient temperature, namely 20° C., reduces the reaction speed by about 20% and a decrease of 15° C. relative to the ambient temperature of 20° C. results in a decrease of the reaction speed by more than 30%.

Similarly, an oxygen saturation of the initial slurry, being understood that the oxygen is initially at equilibrium in the initial slurry (namely about 10 mg/L), adversely affects the reaction speed, the latter decreasing by about 15% in comparison with the reaction speed when the oxygen is at equilibrium. In other terms, while it is necessary to stir the slurry during the reaction, in order to homogenize it, the slurry should not be aerated by stirring too strongly, otherwise the reaction yield will be lowered, by superoxygenation of the medium.

Tests have also been carried out using, as a reducing agent, the ascorbic acid associated to at least one other compound. In this instance, a coagulant such as a polyamine, a polyacrylamide or other. The Applicant has observed, in an unexpected manner, that the use of a coagulant associated to the ascorbic acid allows increasing the reduction speed. The table hereinafter takes on the obtained results, using, as example, as a coagulant a polyamine (coagulant No. 1) and a poly (diallyldimethylammonium chloride) (coagulant No. 2).

% of chromium VI remaining after a
reduction time of:

| | | | |
|---|---|---|---|
| Molar ratio ascorbic | 15 min | 30 min | 45 min |
| acid/chromium: 1/3, | | | |
| pH: 7 | | | |
| Without coagulant nor | 30% | 13% | 5% |
| flocculant | | | |
| With coagulant (40 μL | 15 min | 30 min | 45 min |
| L⁻¹) | | | |
| coagulant No. 1 | 19% | 8% | 3% |
| coagulant No. 2 | 24% | 10% | 4% |

Hence, there is a substantial and quantifiable gain of yield, by the addition of the coagulant, ranging up to 30% during the first 15 minutes, in tests performed in the laboratory.

It is possible to associate other compounds, to the ascorbic acid and to the coagulant, for example a chromium (VI) complexing agent in order to carry out the detection of the chromium (VI) more easily by UV-visible spectrophotometry or by a color indicator allowing controlling the pH easily with the naked eye, without affecting the gain in the reduction speed generated by the association of the ascorbic acid with a coagulant. It is also possible to use, as a compound associated to the ascorbic acid, one or a mixture of one or several reducing agent(s) such as ferrous iron (Fe(II)), zero-valent iron or sodium bisulfite.

A retained embodiment, allowing for a compromise between, on the one hand, the yield and the speed of the reaction and, on the other hand, the cost and the industrial use of such a method, is performed, preferably but not exclusively, by the addition of ascorbic acid at a molar ratio of 1:10 and at a pH comprised between 5.5 and 7, and with a coagulant at a mass comprised between 1:0.002 and 1:25000.

The decrease of the pH of the initial slurry is obtained by a pH adjusting agent introduced in the reaction vat 9 from a pH adjusting member 12. Such a pH adjusting agent is commonly known. For example, it consists of carbon dioxide or, preferably, a strong acid usable in an industrial scale, such as the sulfuric acid. It is conceivable to use another strong acid usable in an industrial scale, for example the hydrochloric acid. Herein, the adjusting member is a vat 12 in which the sulfuric acid or, alternatively, the carbon dioxide, is stored. A means 13 for dosing the amount of sulfuric acid, for example a flowmeter, allows regulating the amount of acid introduced and therefore accurately adjust the pH of the clarified solution. In another embodiment, both the sulfuric acid and the carbon dioxide are used.

The addition of the pH adjusting agent, and therefore of the sulfuric acid, is advantageously performed simultaneously with the addition of the ascorbic acid, provided that the mixture of the pH adjusting agents and the reducing agents with the clarified solution is achieved. Indeed, the Applicant has observed that the adjustment of the pH from 12 to a value comprised between 5.5 and 7 is achieved sufficiently rapidly so that the reduction of the hexavalent chromium by addition of ascorbic acid may be performed simultaneously.

In one embodiment which is not illustrated, the addition of the pH adjusting agent is performed prior to the addition of the ascorbic acid. In this case, the additions of the sulfuric acid and of the ascorbic acid are performed in the same reaction vat 9, in a staggered manner. Alternatively, the additions are performed, in a delayed manner or simultaneously, in two vats disposed in series.

At the end of the reaction time, predefined as being sufficient to obtain a reduction, less than 10 minutes in the example, the reduced slurry is drawn off from the reaction vat 9. A derivation 14 directs the reduced slurry upstream of the chromium content measurement 7 point. Thus, the reduction reaction is controlled and, if necessary, the additions of the pH adjusting agent and/or of ascorbic acid are reiterated so as, on the one hand, to maintain a pre-established pH value and, on the other hand, to bring the hexavalent chromium content to a predefined value, in compliance with the regulations.

Upon completion of the reduction reaction, the hexavalent chromium is reduced into trivalent chromium, barely soluble, present in the form of fine particles. The final slurry, that is to say the clarified effluent not loaded with particles with a hexavalent chromium content at most equal to the content required by the regulations, is directed via a conduit 15 on a means 16 for collecting the trivalent chromium, an activated carbon filter or, advantageously, a sand filter, prior to its ultimate discharge by rejection in nature or its recycling.

At the output of the means 16, prior to its discharge, a measurement 18 of the hexavalent chromium content and an extrapolation into total chromium content, from an analysis performed beforehand, are advantageously carried out on the settled slurry and therefore on the initial effluent cleared from particles, in order to validate the discharge in nature or the recycling of the treated final slurry, in compliance with the regulations.

Preferably, the method comprises an additional step consisting in further adding a pH adjusting agent in the initial slurry, and therefore in the loaded initial effluent, upstream of its introduction in the settling vat 2, typically on the conduit 17 connecting the vat 2 and the supply tray 1. During this step, by adding the same pH adjusting agent as that introduced in the reaction vat, hence the sulfuric acid in this instance, the pH of the slurry, initially basic and close to 12, is lowered to a value comprised between 7 and 8, and therefore close to neutrality. In this case, the hexavalent chromium which is not solubilized but adsorbed on the solid particles of the slurry is released and solubilized in the aqueous phase. In this manner, as much as possible of hexavalent chromium is solubilized prior to its subsequent treatment by reduction with the ascorbic acid.

In one embodiment which is not illustrated, the adjustment of the pH upstream of the settling vat 2 is carried out by an adjusting agent different from that used to adjust the pH in the reaction vat 9, for example another acid.

FIG. 2 illustrates another embodiment of the invention in which the method is implemented on an initial effluent which comprises only but a liquid phase. In this case, the initial slurry is barely, or not at all, loaded with particles but contains, de facto, chromium. The method is similar to that described before, starting from the treatment of the effluent, after a natural settling. The reference numerals referring to similar means and/or members are multiplied by 10 with reference to the equivalent reference numerals of FIG. 1.

It is conceivable that in this case, the plant for implementing the method is simpler since it is no longer necessary herein to provide for a treatment of the particles collected after settling. Indeed, either this treatment has been carried out beforehand or it is not necessary, the initial effluent being inherently devoid of any solid phase. For example, the method illustrated in FIG. 2 is either carried out in a continuous manner at the output of a basin for settling initial effluents or in a discontinuous manner on a given volume of an initial effluent which has been settled beforehand. Thus, it is possible to consider a plant capable of implementing the method according to this embodiment in order to treat an effluent coming from a remote location.

Alternatively, a plant for implementing the method according to FIG. 2 is movable and is used for a given period, in situ, for example in case of a momentary pollution by the chromium present in a liquid effluent devoid of solid phase. In this case, the plant is sized so as to be easily transportable by truck. Alternatively, the plant is configured to have dimensions corresponding to those of a container, thereby enabling, for example, transportation by ship.

A supply 10 of initial effluent is performed, in the example, directly from the effluent production plant, according to the arrow F1. It is conceivable that a supply tray could be provided in order to regulate the supply of effluent. The latter is introduced, preferably but not mandatorily, in a settling vat 20. This vat 20, with a capacity smaller than that of the vat 2, serves in perfecting the settling of the effluent, in particular when the latter comes from natural settling basins or wetlands. In other terms, the purpose is to obtain an initial effluent devoid of any solid phase.

At the output of the vat 20, the effluent is sent, via a conduit 21, according to the arrow F2, towards the settling basins, of course if the effluent has been drawn off initially from these basins.

A pH measurement 200 is performed on the initial effluent, upstream of the vat 20. Subsequently to its passage in the vat 20, the effluent is introduced in a vat 40, in order to be stirred and homogenized. As in the case illustrated in FIG. 1, a draw-off 50 allows sending the effluent onto a filtering member 60, for example a sand filter, prior to its re-introduction in the vat 40. Measurements 70, 80, respectively of the pH and of the hexavalent chromium content, are performed on the effluent coming out from the vat 40, upstream of its introduction in a vat 90 in which the reduction is carried out, by the addition of ascorbic acid coming from a reducing agent supply vat 100. Like before, the ascorbic acid is added at a pH comprised between the neutral pH and the initial pH, basic and close to 12, of the initial effluent. The decrease of the pH is obtained by the addition, preferably simultaneously, of an adjusting agent coming from a pH adjusting member 120.

The adjusting member 120 is also connected to the supply tray 10, via a conduit 170, in order to inject the pH adjusting agent in the initial effluent, prior to its passage in the vat 20, this being for the same reasons as those described in FIG. 1.

Once the reduction is performed in the vat 90, with the same parameters as for the embodiment represented in FIG. 1, the final effluent is discharged via a conduit 150 towards a filtering member 160, prior to its discharge, namely its recycling or its rejection in nature. If necessary, a control of the chromium content, indicated by the reference numeral 161, is carried out at the output of the filtering member 160.

The different members composing a plant capable of implementing the method according to the embodiments of FIGS. 1 and 2 consist of at least a homogenization vat 4; 40, a reaction vat 9; 90 and ascorbic acid and pH adjusting adding members 10, 12; 100, 120. These members are known, as such, by those skilled in the art. Such a plant may include a different number of members and/or different dimensions, depending on the nature and the volume of effluent to be treated. It is conceivable that such a plant may comprise elements others than those described. In particular, it may consist of duplicate elements, for safety considerations, or elements for collecting complementary data, for example regarding the flow rate in the conduits of the plant, temperature probes, oxygen content probes or other sensors. Advantageously, such a plant comprises various members for controlling the process, these members being adapted to allow enable the remote monitoring and control of the plant and the management of the process.

FIG. 3 illustrates another embodiment of the invention. Herein, the initial effluent comes from a settling basin 101 of an effluent treatment station. Hence, it is mostly devoid of solid particles. Two vats, one intended for homogenization 400 and a complementary vat intended for settling 401 the effluent are mounted in cascade. The vat 400 is connected, on the one hand, to a sand filter 161 and on the other hand to a reaction vat 900. The vat 900 is connected to an ascorbic acid supply vat 121 and to a sulfuric acid supply vat 122. The vat 900 is also connected to a second sand filter 162. It is to be noted that, in this instance, the filter 161 allows sending a portion of the filtered effluent back in the settling vat 401 and a portion in the settling basin 101. The latter also receives, for an additional settling, a draw-off from the vat 401 and a collection of the supernatant of the basin 101 is sent in the vat 401. The fact of having a so-called cascade settling, by passage of the effluent, several times if necessary, from the station 101 to the vat 401, allows clearing the effluent from these solid particles to the maximum extent possible, and therefore, collecting de facto part of the chromium present therein. The supernatant of the content of the vat 401, cleared as much as possible from solid particles, passes in the vat 400, for example by spillover.

Similarly, once filtered, the filter 162 discharges a portion of the effluent towards the settling basin 101, the other portion being definitely discharged.

FIG. 4 represents a plant for implementing the method. Such a plant, also named skid, has dimensions enabling it to be easily displaced, for example on a truck. For it to be operational, it only requires fluid and electricity hookups. Hence, its use is easy. For this purpose, the skid 500 comprises a metallic framework accommodating at least the different members necessary to the implementation of the method.

In particular, the skid 500 allows implementing the method illustrated in FIG. 3. The different constitutive elements of the skid 500, herein the vat 401, the filters 161, 162, the vats 121, 122 intended for supplying respectively the ascorbic acid and the sulfuric acid as well as the reaction vat 900 are visible. Other members, such as pumps, pH sensors, flowmeters, valves and other elements, for example safety elements, are provided on the skid 500. In all cases, the elements of the skid 500 are adapted, in number, type and dimensions, to enable the implementation of the method according to the different embodiments. It is conceivable that such as skid could have dimensions such that it is easily displaceable, whether for example by truck or in the form of a container.

1. A method for reducing the chromium content, in particular the hexavalent chromium content, present in a liquid effluent loaded with solid particles, called the initial effluent (1; 10), comprising at least one reduction step (9; 90; 900) by the addition, to the initial effluent, of a weak organic acid (10; 100; 121) in an amount sufficient to reduce the hexavalent chromium present in the initial effluent into a lower valency, namely into trivalent chromium, said step being followed by a step of discharging the treated liquid effluent, called the final effluent, characterized in that it comprises at least the following steps of:
carrying out, prior to the reduction step, a step (2; 20; 101, 401) of collecting the solid particles present in the initial effluent, at least by settling,
performing the reduction step (9; 90; 900) after adjustment (12; 120; 122) of the pH of the initial effluent to a pH value lower than the initial pH of the initial effluent while remaining compatible with a discharge of the final effluent at this pH value.

2. The method according to claim 1, characterized in that the weak organic acid is the ascorbic acid and in that the adjustment (12; 120; 122) of the pH is realized by the sulfuric acid.

3. The method according to claim 1, characterized in that the weak organic acid is the ascorbic acid and in that the adjustment of the pH is realized by the carbon dioxide.

4. The method according to claim 1, characterized in that the adjusted pH of the final effluent is comprised between 5.5 and 7.

5. The method according to claim 1, characterized in that, during the settling step (2; 20; 101), the pH of the effluent is adjusted (17; 170) to a pH value close to the neutral pH.

6. The method according to claim 5, characterized in that the settling step (2; 20; 101) is followed by a filtration (6; 60; 161).

7. The method according to claim 1, characterized in that, prior to the reduction step (9; 90; 900), the effluent is homogenized (4; 40; 400).

8. The method according to claim 7, characterized in that, subsequently to the homogenization (4; 40; 400) and prior to the reduction (9; 90), at least one measurement of the hexavalent chromium content (7; 70) and of the pH (8; 80) is performed.

9. The method according to claim 1, characterized in that, during the reduction step (9; 90; 900), the weak organic acid is associated to at least one other compound.

10. The method according to claim 9, characterized in that the compound associated to the weak organic acid during the reduction step is a coagulant.

11. A plant (500) for implementing the method according to claim 1 comprising at least one vat (9; 90; 900) in which the reduction of an initial effluent is carried out, a member (10; 100; 121) for adding a weak organic acid forming the reducing agent, the adding member (10; 100; 121) being connected to said vat (9; 90; 900), characterized in that it also comprises at least one member (12; 120; 122) for adjusting the pH of the initial effluent and at least one settling vat (401).

12. The plant according to claim 11, characterized in that the pH adjusting member (12; 120) is connected to the settling vat (2; 20).

13. The plant according to claim 11, characterized in that it comprises at least one filtering member (6, 16; 60, 160) such as a sand filter or an activated carbon filter.
